(19) United States
(12) Patent Application Publication
(10) Pub. No.: US 2011/0253482 A1
(43) Pub. Date: Oct. 20, 2011

(54) Device, system and method for assembling food orders

(76) Inventors: James C. Purgatorio, Woodridge, IL (US); Peter Rivera-Pierola, Chicago, IL (US); Roger Smith, Plainfield, IL (US); Roger Carroll, Downers Grove, IL (US); Henry T. Ewald, Roselle, IL (US); Thomas Tapper, Schenectady, NY (US); Edward P. Bridgman, Bolingbrook, IL (US); Paul G. Simmons, Glen Ellyn, IL (US)

(21) Appl. No.: 12/799,046

(22) Filed: Apr. 16, 2010

(51) Int. Cl. A47J 43/00; B65B 67/12; A21C 15/00; F24C 7/04; B65D 30/00

(52) U.S. Cl. 186/38; 392/416; 383/37; 99/450.4; 248/95

(57) ABSTRACT

A device for assembling orders of food from prepared food items having multiple sides on different sides of the device is disclosed. Also disclosed is a system including the device and a method of assembling orders of food. Each side has a plurality of side receptacles accessible to a worker at the side. Adjacent to the sides is a holding area for holding prepared food items. Preferably the heated holding area has a central portion that is heated.

### TECHNICAL FIELD

Generally, the invention relates to quick-service restaurant equipment and methods. More particularly, the equipment includes a device for assembling orders that may be used in conjunction with a food preparation device.

### BACKGROUND OF THE INVENTION

In quick-service restaurants, hundreds or even thousands of orders may be served in a day at a single restaurant. The orders must be served quickly even though the food items may be made-to-order. To serve an order first requires assembly of the order, which may be composed of prepared and packaged items, including, for example, food items, condiments, napkins, promotional items, toys and to place the food items on a tray or in a bag. There is a need for a device that allows for the efficient assembly of food orders, a system incorporating such a device, and a method of assembling food orders using the device.

Quick-service restaurants are typically relatively small compared to the volume of food served. In addition, at peak times, the area where orders are taken, assembled and served can be very busy, with a plurality of workers in a relatively small area with several workers assembling orders. There is a need for a device for assembling food orders that is both compact and allows several workers to assemble orders simultaneously.

### SUMMARY OF THE INVENTION

In accordance with the present invention, a multi-sided, self-contained order assembly device and method for assembling food orders for customers from prepared food items at a quick-service restaurant is provided. In one embodiment, the assembly device includes a first side having an outer periphery at which food orders can be assembled by a first worker, the first side having a plurality of first side receptacles accessible to the first worker located at the outer periphery of the side. The device includes a second side having an outer periphery at which food orders can be assembled by a second worker, the second side having a plurality of second side receptacles accessible to the second worker located at the outer periphery of the second side. An at least generally centrally located food item holding area is provided for holding prepared food items. The food item holding area is accessible by a worker located at the outer periphery of either of the first and second sides. The order assembly device includes a food inlet side, distinct from the first and second sides through which the prepared food items may pass to the food item holding area.

In accordance with another aspect of the invention, the food inlet side has an inlet portion that slopes downwardly from the inlet and towards the food item holding area for encouraging prepared food items to slide towards the food item holding area.

The order assembly device may further include a heater for heating the food item holding area. This can be conveniently accomplished by, for example, any suitable heater which can be a radiant heat source or a forced air heater, for example. At least a portion of the food item holding area can have a dark surface for absorbing radiant heat from the radiant heat source. Preferably, the dark surface is black and may be black anodized aluminum or other metal, which can be configured to act as a heat sink for the radiant energy.

In accordance with another aspect of the invention, the assembly device may further include a third side at which food orders can be assembled by a third worker, the third order side having a plurality of third side receptacles accessible to the third worker at the outer periphery of the third side with the food item holding area being accessible by a worker located at the outer periphery of the third side.

The plurality of side receptacles, including for the first, second and/or third sides can be configured to contain items needed for food order assembly as desired and may include, for example, one or more bag receptacles sized and configured to hold a plurality of folded bags in a substantially vertical alignment.

In accordance with another aspect of the present invention, a system for assembling food orders from customers at a quick-service restaurant is provided that is composed of a multi-sided, self-contained order assembly device. In one embodiment, the device includes a first side having an outer periphery at which food orders can be assembled by a first worker, the first side having a plurality of first side receptacles accessible to the first worker at the outer periphery of the first side. The device further includes a second side having an outer periphery at which food orders can be assembled by a second worker, the second side having a plurality of second side receptacles accessible to the second worker at the outer periphery of the second side. The device further includes an at least generally centrally located food item holding area for holding prepared food items, the food item holding area accessible by a worker located at the outer periphery of either of the first and second sides. The system may further include a food inlet side, distinct from the first and second sides, through which the prepared food items may pass to the food item holding area.

In accordance with another aspect, the system may further include a sandwich preparation device for preparing sandwiches. The sandwich preparation device may include cold storage for holding condiments selected from the group of onions, tomatoes, lettuce, combinations thereof and other items as desired.

The system may also include structure for transferring sandwiches prepared at the sandwich preparation device to the food item holding area. The structure for transferring sandwiches may include a ramp connected to and sloping towards the heated holding area. Alternatively, a conveyor may be used to transport the sandwiches to the heated holding area.

The system may further include a human-readable display for displaying orders to be assembled. The display typically will be oriented to be viewable by a worker working at one of the order assembly sides.

In accordance with another aspect of the invention, a method of assembling an order of food at a multi-sided, self-contained order assembly device for assembling food orders for customers from prepared food items is provided. The self-contained order assembly device can be as previously described. The method includes ascertaining food order items needed to fill an order, selecting an appropriate order container from one of the first or second side receptacles, obtaining order items from the food item holding area and placing the obtained order items into the selected order container.

In another aspect, the method may further include placing prepared food order items into the holding area for subsequent selection and placement into an order container.

In accordance with another aspect of the invention, the ascertaining food order items needed to fill an order may be information obtained from a video display.

### BRIEF DESCRIPTION OF THE DRAWINGS

FIG. 1 is a front/left side perspective view of a first embodiment of an order assembly device in accordance with the invention, having three working areas.

FIG. 2 is a front elevation view of the embodiment of FIG. 1.

FIG. 3 is a front/right side perspective view of the embodiment of FIG. 1.

FIG. 4 is a plan view of the device of FIG. 1 in combination with a food preparation device.

FIG. 5 is a front/left side perspective view of a two working area embodiment of an order assembly device in accordance with the invention.

FIG. 6 is a front elevation view of the embodiment of FIG. 5.

FIG. 7 is a front/right side perspective view of the embodiment of FIG. 5.

FIG. 8 is a front perspective view of the base of an alternate embodiment two working area order assembly device in accordance with the invention.

FIG. 9 is a left side perspective view of the embodiment of FIG. 8.

FIG. 10 is a front left side perspective view of a fourth embodiment of an order assembly device of the present invention.

FIG. 11 is a front right side perspective view of the embodiment of FIG. 10.

FIG. 12 is a plan view of the embodiment of FIG. 10.

FIG. 13 is a front elevation view of the embodiment of FIG. 10 with associated point-of-sale registers.

FIG. 14 is a right side elevation view of the embodiment of FIG. 10.

FIG. 15 is a front/left side perspective view of a left module of an embodiment of an order assembly device that includes parts illustrated in FIGS. 16-19.

FIG. 16 is a front/left side perspective view of a right module of the embodiment of FIG. 15.

FIG. 17 is a front/left side perspective view of a frame of the embodiment of FIG. 15.

FIG. 18 is a front/right side perspective view of a front module of the embodiment of FIG. 15.

FIG. 19 is a front/right side perspective view of a core module of the embodiment of FIG. 15.

FIG. 20 is a plan view of a convex embodiment of an order assembly device of the invention.

FIG. 21 is a plan view of a concave embodiment of an order assembly device of the invention.

FIG. 22 is a side elevation view of a receptacle for bags for use as part of the invention.

### DETAILED DESCRIPTION OF THE INVENTION

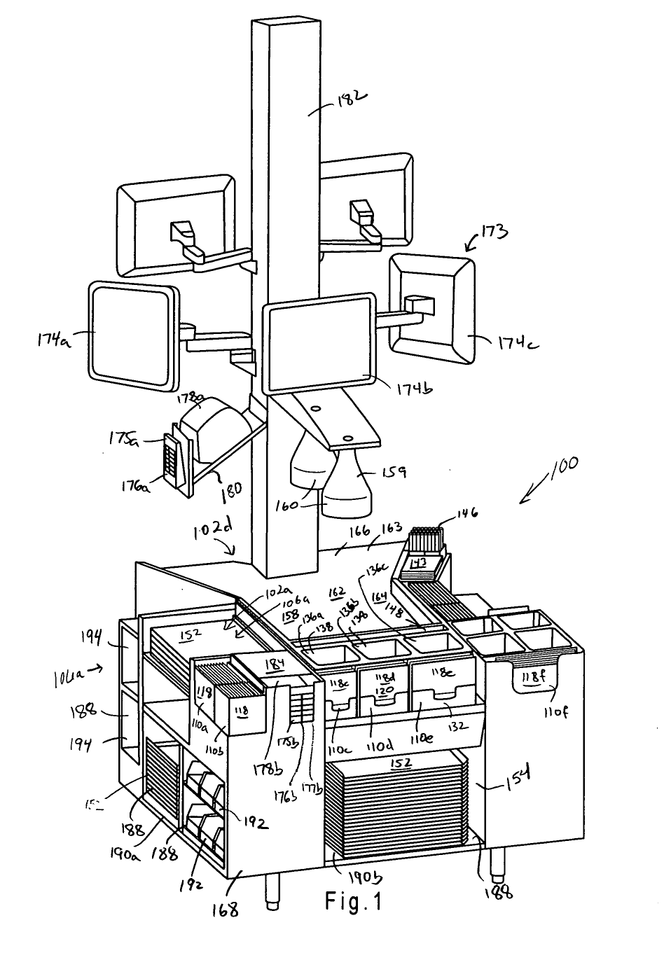

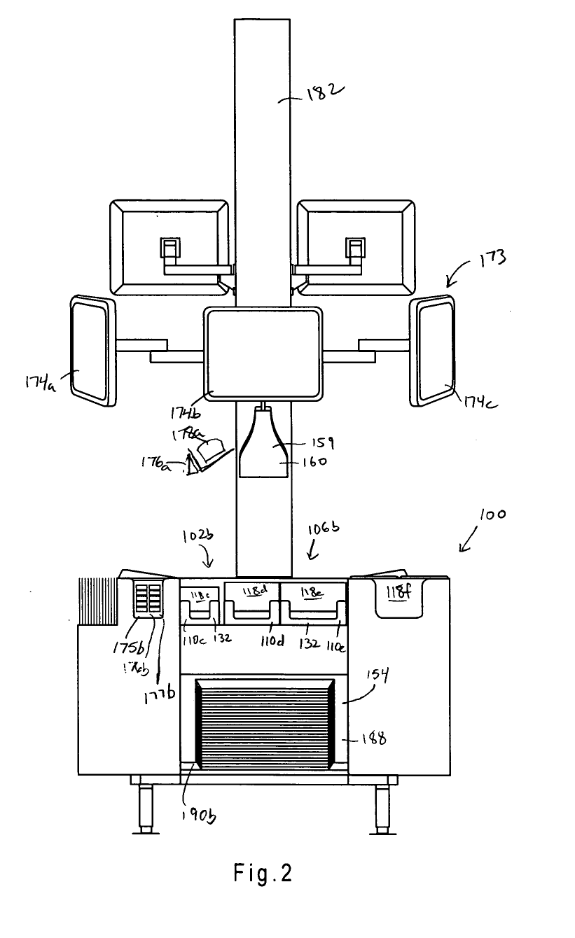

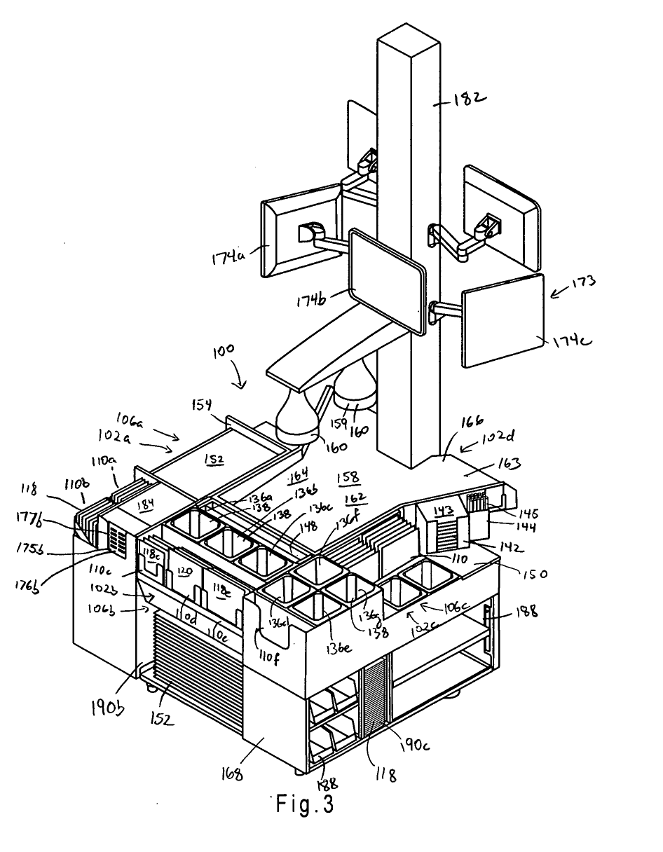

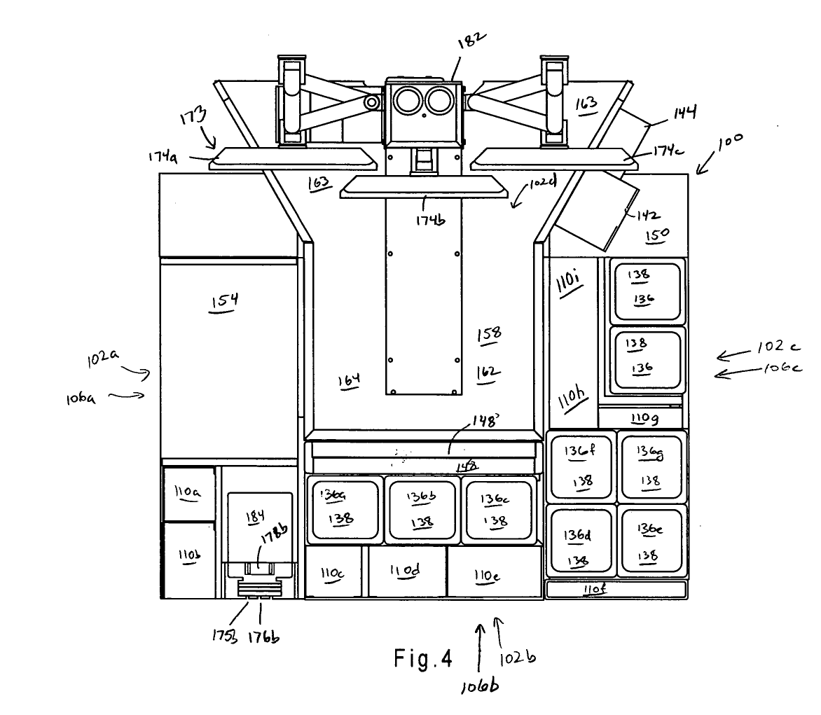

The food order assembly device of the invention may be in a desired configuration selected from a number of different suitable configurations. Referring to FIGS. 1-4, a first embodiment, food order assembly device 100, is configured for three-sided operation. In particular, food order assembly device 100 has four side regions 102a-102d. Food order assembly device 100 may be in any desired shape, although a substantially straight-sided and rectangular shape is preferred. Side regions 102a-102c each defines a respective one of the total of three work or order assembly areas 106a-106c, respectively. Order assembly area 106b is optimized to be the primary side for assembling orders from front counter orders or in-restaurant customer orders. Order assembly area 106a is a secondary side for assembling orders from front counter or in-restaurant customer orders and can be used, for example, when the volume of orders exceeds the capacity of order assembly area 106b. Order assembly area 106c is optimized for assembling orders for drive-thru customers. The number, type and location of sides may vary from one embodiment to another. It is to be understood that the terms “side,” “sided” and variations of these terms do not require that the side be straight or generally straight, or that a “side” terminate at a corner. As described herein, the side may be curved or any desired shape.

Order assembly areas 106a-c have various receptacles that provide supplies for assembling a food order. These supplies are typically non-perishable and can be stored safely at ambient temperature. Of course, the invention is not limited to the storing or use of non-perishable supplies. As shown in FIGS. 1-3, each side has order vessel receptacles, such as container receptacles 110, container receptacles 148 or tray receptacles 154 so that order vessels like bags 118, boxes 120, bags, and trays 152 are accessible to workers at the device.

Receptacles 110 are sized and configured to hold a plurality of folded bags 118 or paperboard containers 120 in a substantially vertical alignment. Container receptacle 110d may be sized and configured to hold paperboard containers or boxes 120 while the other receptacles 110 are sized and configured to hold bags 118. As can be seen in FIGS. 22 and 18, bags 118, 518 which are folded, have a bag body 122, 522, bag bottom 124, 524 which is folded over body 122, 522 and an open mouth 126. Bags 118, 518 are typically made of paper. As can be seen in FIGS. 22 and 18, container receptacles 110, 510 are sized and configured to hold bags and container receptacles 110, 510 preferably have a base or closed bottom 128, 528 an open top 130, 530 and a partially open front 132, 532. The horizontal depth of base or bottom 128, 528 is less than the horizontal depth of top 130, 530 for facilitating the loading and removal of folded bags 118, 518 in an upside down position, causing bags to “fan out” along the top edges thereof, making it easier to grasp a single bag. More specifically, partially open front 132, 532 is a generally planar front member that has at least a lower portion that is angled outwardly from bottom to top to facilitate the “fanning open” of bags 118, 518 as illustrated in FIG. 22. The at least partially open front 132, 532 is preferably configured to allow a worker's hand to slip between the body 122, 522 and the bottom 124, 524 of folded bag 118, 518 to facilitate the removal of an individual bag from container receptacle 110, 510. Bags 118 are typically of quick-service restaurant-standard sizes. Bags 118c, 118d, 118e and 118f may be A size, B size, C size and D size quick-service restaurant-standard bags, respectively. For ease of access bag container receptacles are mounted to the front of order assembly areas 106 and are top-loading.

Some or all of order assembly areas 106a-c may have receptacles 136 associated with one or more of order assembly areas 106a-c. Receptacles 136 have open tops and are located at the top of order assembly areas 106. They may also be located interiorly of container receptacles 110. Receptacles 136 may include open top pans 138 sitting in wells. Pans 138 can be used to store straws and condiments, for example. Condiments that may be stored in the different receptacles 136 or pans 138 include ketchup, mustard, barbecue sauce, relish, dipping sauces, salt, pepper, salsa, etc. The condiments may be packaged in commercially sterile disposable packages that are usually less than 1 oz, more typically less than 0.5 oz. Unlike food preparation devices, wells are typically neither heated nor cooled. Receptacles 136d and 136e may be used to store toys, for example.

Top-accessible and top-mounted receptacles in addition to receptacles 110 and 136 include a receptacle 142 for holding napkins 143, straw receptacle 144 for holding straws 145, and receptacle 148 for holding plastic bags that are relatively wide compared to their height and which are often used for holding salads. Receptacle 148 may have a bar or divider 148′ for hanging the plastic bags.

Receptacles 110a-110b are oriented to face a worker at order assembly area 106a so that the contents of these receptacles are apparent to a worker standing at order assembly area 106a. Receptacles 110a-110b are part of order assembly area 106a and are readily accessible to a worker standing at order assembly area 106a. Similarly, receptacles 110c-110f, 136a-136g and 148 are oriented to face a worker at order assembly area 106b so that the contents of these receptacles are apparent to a worker standing at order assembly area 106b. Also, receptacles 110g-110i, 136d-136g, 142, and 144 are similarly oriented to face a worker at order assembly area 106c so that the contents of these receptacles are apparent to a worker standing at order assembly area 106c. For purposes of this patent, receptacles 136d-136g can be considered to be part of both order assembly areas 106b and 106c as they are located so that their contents are readily accessible to workers standing at order assembly areas 106b and 106c and their contents are apparent to workers standing at order assembly areas 106b and 106c. As used herein, “accessible” means that an average adult human worker can reach the receptacle and the contents therein without the need for moving the position of the worker's feet.

Order assembly area 106c has a work area 150. Work area 150 is an open planar, substantially horizontal area on top of side region 102c where bags 118 or boxes 120 may be placed. Orders including prepared sandwiches, condiments, napkins 143, and straws 145 may then be placed in bags 118 or boxes 120 on work area 150. Front counter order assembly areas 106a and 106b generally do not have a dedicated work area as orders may be assembled on a tray 152 placed on top of tray holder 154 and receptacles 136a-136c, respectively. Tray holder 154 may be a receptacle for holding trays 152 at order assembly area 106a.

Food order assembly device 100 has a holding area 158 heated by a heating device 159. Heating device 159 is sized to maintain food warm in the holding area, but preferably without cooking the food. As shown, the heating device 159 can be one or more heat lamps 160. Alternatively, heating device 159 may include a heated surface, such as a bottom or supporting surface 162 of heated holding area 158, heated from below by a resistance heater, a hot air curtain, or a combination of any of the three. If desired, only part of the holding area is heated. The remainder of the holding area may be at ambient temperature. Alternatively, a portion of the holding area is heated, a portion chilled or cooled and still another portion could be at ambient temperature. For example, a central portion of the holding area could be heated or cooled and the surrounding or peripheral area of the holding area could be cooled or heated. The heated or cooled area could also be composed of a cabinet, the interior of which is heated or cooled and could be accessible from each of the work areas of the food order assembly device 100. The cabinet could have doors or vertically hanging curtains to help contain the heated or chilled air inside the cabinet. Preferably, supporting surface 162 is made of a suitable heat absorbing material when used in combination with heat lamps 160 such as aluminum anodized with a dark color such as black, brushed stainless steel, and colored plastics having a suitable heat resistance.

Holding area 158 can also include an inlet 163 and a portion 164 that is proximate order assembly areas 106a-c. Inlet 163 is where prepared sandwiches from a sandwich preparation area are placed. Inlet 163 may include ramp 166 which extends beyond base 168 of food order assembly device 100 and side region 102d. Holding area 158 slopes away from inlet 163 and downwardly towards centrally located portion 164 so that food items placed in inlet 163 tend to slide to portion 164. Portion 164 is located substantially central to food order assembly device 100 and proximate to order assembly areas 106a-c so that prepared food items are readily accessible to workers at order assembly areas 106a-c.

Food order assembly device 100 may also have an order communication system 173 or components thereof. Order communication system 173 is used to communicate orders to be assembled to workers at food order assembly device 100. System 173 preferably has a human-readable display 174 for each order assembly area 106. Each display 174a, 174b and 174c can then display orders to be assembled at the corresponding order assembly area 106a, 106b or 106c, respectively. System 173 also has one or more input interfaces 175, typically one interface 175 for each display 174. Input interface 175 may allow a worker to indicate that an order has been assembled so that the order is no longer shown on display 174 and a new order is shown instead. Input interface 175 may be a bump bar 176, for example, which has a keypad 177 having typically less than 10 keys, allowing a worker to signal completion of an order which is then removed from the screen(s) by the worker depressing the bump bar in reference to that particular order. Bump bars 176 may be located at the order assembly areas 106, such as bump bars 176a and 176b at order assembly areas 106a and 106b, or at a different location (not shown) such as where the order is delivered to a customer, for example, a drive-thru window. The drive-thru bump bar and label printer may be located in a location as desired, for example, at the drive through window or at the order assembly table.

Displays 174 may be connected to a suitable computer processor (not shown) that is connected to printers 178 and to POS terminals (not shown) for taking orders from customers. Each display 174 may have a corresponding printer 178. Printers 178 are typically found adjacent to bump bars 176. Typically, food order assembly device 100 will have at least one display 174, at least one input interface 175, such as bump bar 176, and one printer 178. More typically, front-counter order assembly areas 106a and 106b will each have one display 174a or 174b, at least one input interface 175a or 175b, such as bump bar 176a or 176b, and one printer 178a or 178b. Drive-thru order assembly area(s) 106c typically have a display 174c, but frequently do not have an input interface and printer, as the input interface and printer may be located elsewhere. Printers 178 may print labels that may be adhered to a bag 118 for identifying the order in bag 118. Suitable printers include thermal printers such as Ithaca 8000 and 8040 receipt printers. Suitable label stock includes 40 mm and 80 mm NCR linerless label rolls designed to be used with the Ithaca 8000 and 8040 printers. Printers 178 and input interfaces 175 are preferably located so that they are readily accessible to a worker at the corresponding order assembly area 106. For example, printers 178 and input interfaces 175 may be located on a stand 180 attached to a column 182, such as printer 178a and input interface 175a are for order assembly area 106a. Alternatively, they may be located in base 168, such as printer 178b and input interface 175b. Input interface 175b is mounted to base 168 so that keypad 177b faces outwardly of base 168. Printer 178b is partially covered by cover 184. However, labels output by printer 178b are accessible to a worker at order assembly area 106b without removing cover 184.

Displays 174 and heat lamps 160 may be attached to stand or column 182. Ramp 166 may extend around opposing sides of column 182. Conceivably, displays 174, lamps 160, printer 178a and input interface 175a could be hung directly or indirectly from the ceiling of the restaurant. Conceivably, some storage could also be provided above base 168 supported by base 168, stand or column 182, or the ceiling.

Food order assembly device 100 and order assembly areas 106 typically have underneath storage 188 as desired in base 168 accessible from side regions 102. Underneath storage 188 may be used to store items needed to replenish whatever condiments, trays, napkins, bags, promotional items, toys or other consumables are needed to fill an order and may include receptacles of various kinds such as open shelving 190, closed shelving, bins 192, bins 194, drawers and combinations thereof. Underneath storage 188 may be used for storing items for which top-accessible storage is lacking. For example, as illustrated, order assembly area 106a lacks receptacles 136 like primary order assembly area 106b but has side-accessible bins 192 and 194, which are readily accessible to a worker at order assembly area 106a and are oriented so that their contents are apparent to a worker standing at order assembly area 106a. Bins 192 and 194 are particularly suitable for storing condiments, toys and the like. Underneath storage 188 may be used for storing items which can be used to refill top-accessible receptacles 110, 136, 148 and 154. For example, shelving 190a-190c is shown holding trays 152 and bags 118 which are used to replenish top-accessible receptacles 154 and 110, respectively.

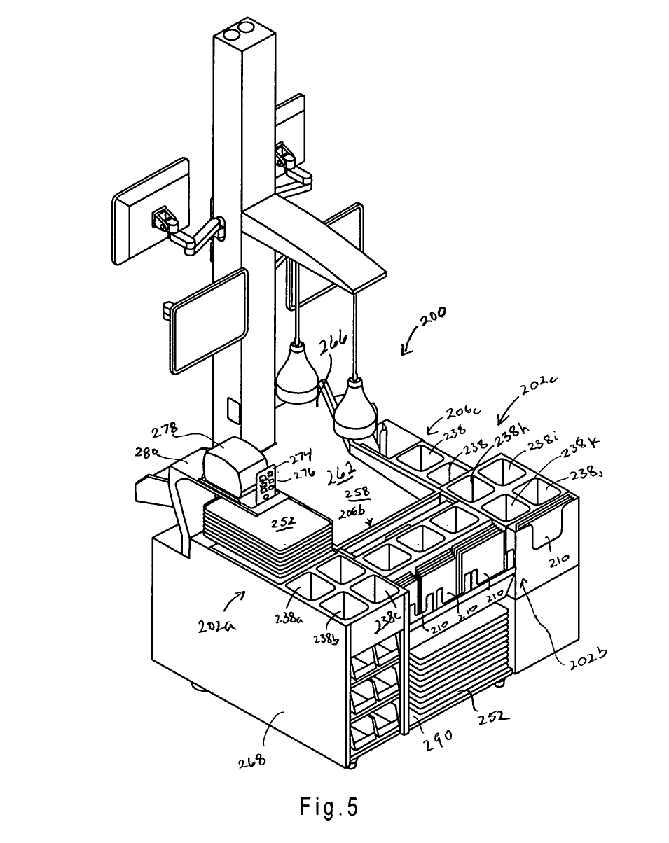

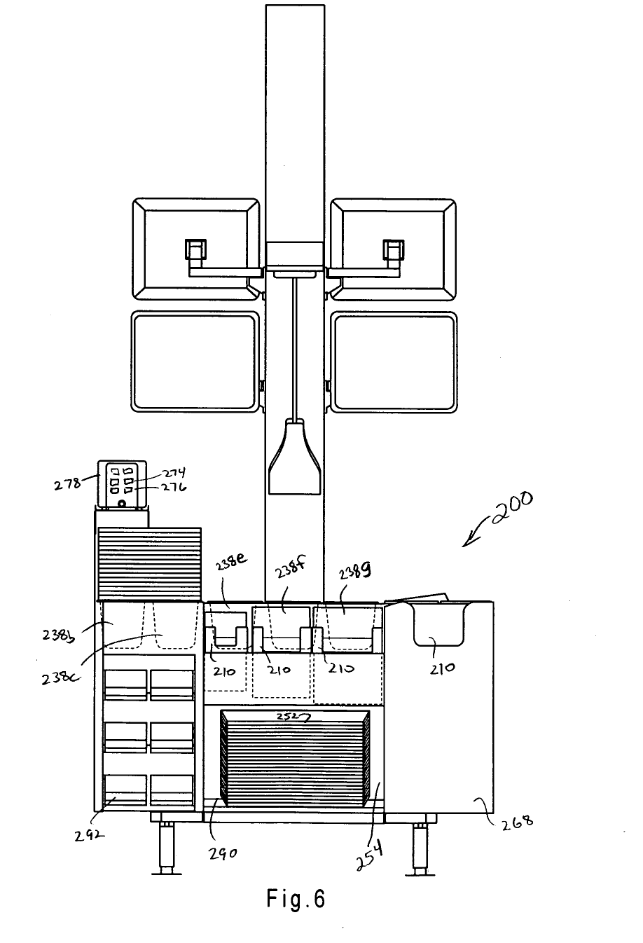

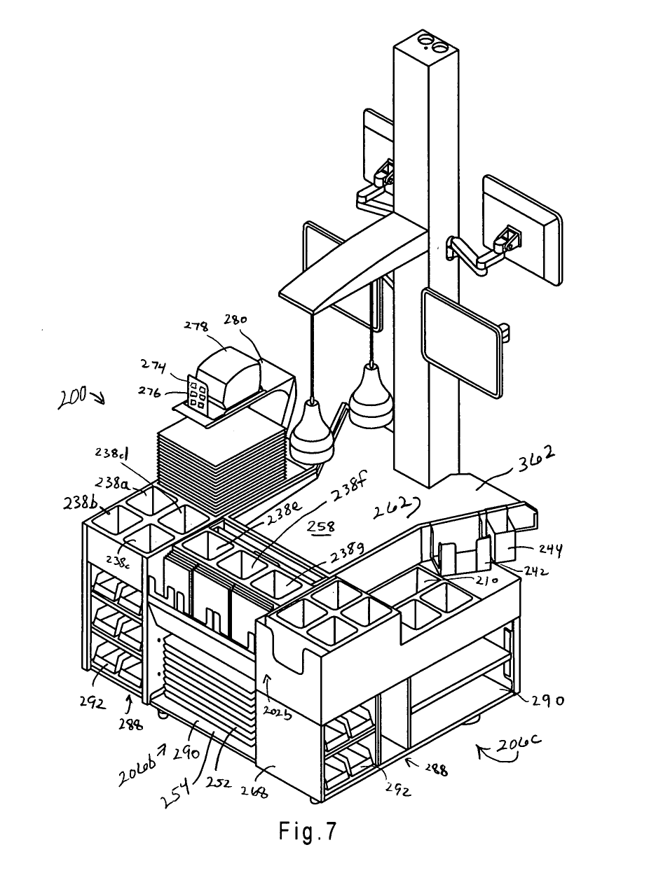

An alternate embodiment food order assembly device 200 in accordance with the invention is shown in FIGS. 5-7, having two food order assembly areas 206b and 206c. Device 200 is very similar to food order assembly device 100 previously described. For convenience, parts of device 200 will be referred to by item numbers in the range of 200-299 while parts of food order assembly device 100 are referred to by item numbers in the range of 100-199. For this and other embodiments, parts having item numbers differing only by 100 or multiples of 100 are substantially similar except as specifically described or is apparent from the FIGS. The principal difference between device 200 and food order assembly device 100 is the absence of a secondary side such as order assembly area 106a on side 202a of device 200. Although it is possible to work at side 202a, trays 252, input interface 274 (which is shown as bump bar 276), printer 278, and input interface stand 280 impede access to heated holding area 258. Order assembly area 206b extends along side 202b and includes receptacles 290 and pans 238a-238k. Base 268 of device 200 as shown in FIG. 5 does not have side-accessible storage 288 along side 202a. Such storage could be provided particularly along side 202a, particularly for providing storage to replenish receptacles 210, 238, 242, 244 and 254, for example. Order assembly area 206c may be identical to order assembly area 106c.

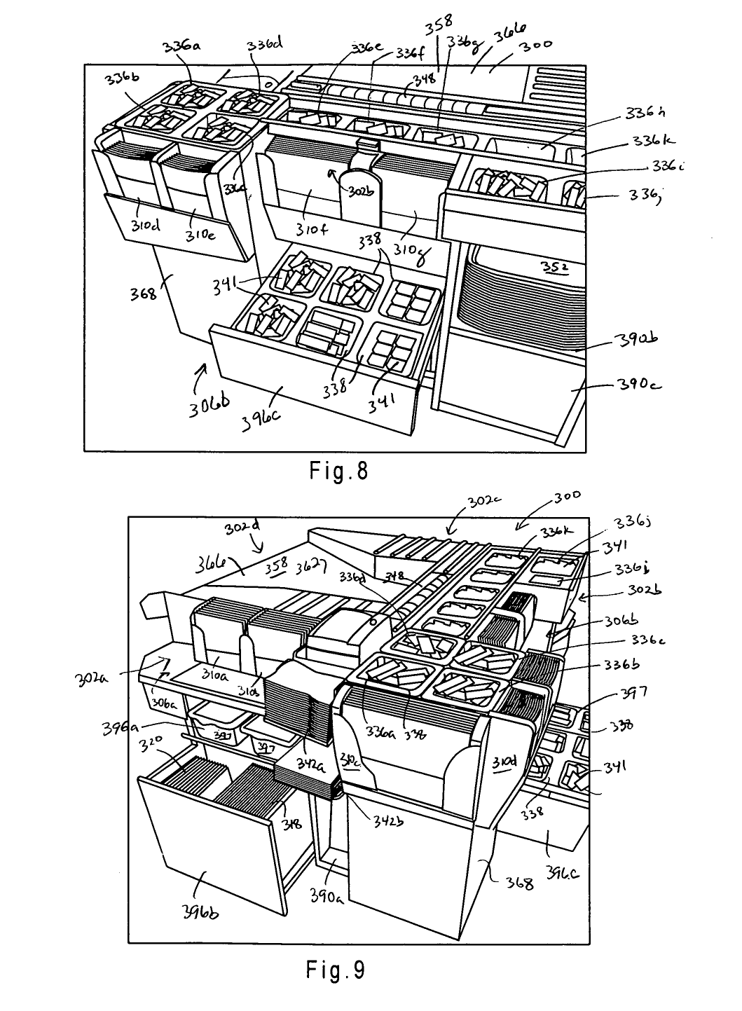

A second two-side embodiment of a food order assembly device 300 is shown in FIGS. 8-9. Device 300 is very similar to device 200. For convenience, parts of device 300 will be referred to by item numbers in the range of 300-399. Parts having item numbers differing only by 100 or multiples of 100 are substantially similar except as specifically described or is apparent from the FIGS. Device 300 has sides 302a-302d. Device 300 has a drive-thru side 306a on side 302a and a front-counter side 306b on side 302b. Drive-thru side 306a has bag receptacles 310a-310c, receptacles 336a-336d, napkin receptacles 342a-b, and shelf 390a. Bag receptacle 310c, as well as bag receptacles 310d and 310e of side 306b are mounted to the exterior of base 368. Unlike devices 100 and 200, device 300 has drawers 396a-396b. Drawer 396a has an open or partially open front. Drawer 396a may be used to hold pans 397 of condiments 341. Pans 397 as shown are less tall than pans 338 although they have the same size opening. The size of pans 338 and 397 may vary.

Drawer 396b is configured to hold bags 318 and boxes 320 so that bags 318 and boxes 320 are positioned to easily reload receptacles 310a-310g. For example, bags can be contained in a quantity and arrangement similar to the bags contained in receptacles 310a-310g to permit easy replenishment of bags into receptacles 310a-310g.

Front-counter side 306b has container receptacles 310d-310g, receptacles 336a-336k, receptacle 348, shelves 390b-390c, and drawer 396c. Shelves 390b-390c are sized to hold trays 352. Drawer 396c is used to hold a plurality of pans 338 of condiments 341, such as 9 pans 338, (6 pans are visible in FIG. 8). Pans 338 of condiments 341 in drawer 396c may be placed in wells where condiments 341 are conveniently located for workers assembling orders. Supports and drawer sides can hold pans 338 by their rims in the same way that pans 338 are held in wells. Drawer 396c extends below heated surface of heated holding area 358.

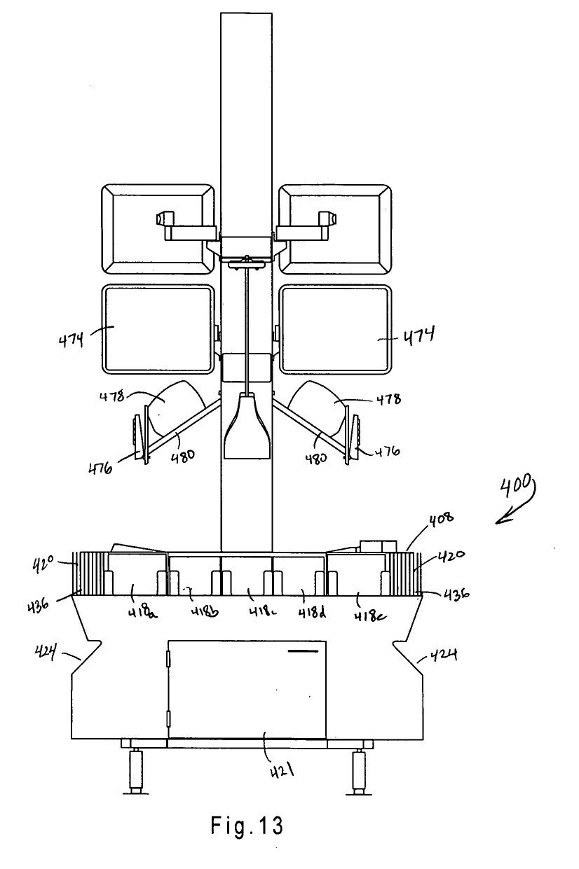

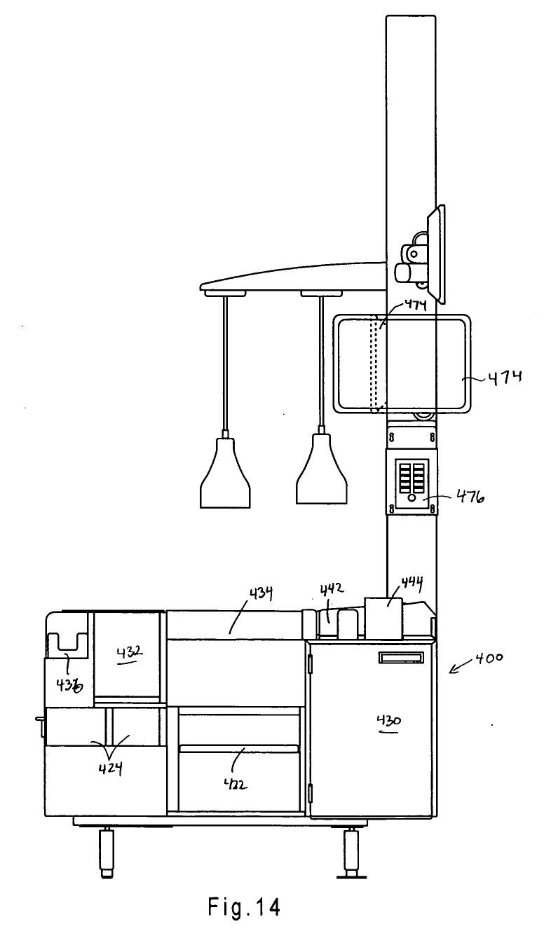

A fourth embodiment of the invention is a food order assembly device 400 shown in FIGS. 10-14. For convenience, parts of device 400 will be referred to by item numbers in the range of 400-499. Although the item numbers for this embodiment frequently do not match the item numbers for similar parts of the other embodiments, parts of device 400 are or can be generally similar to those of devices 100, 200, or 300 previously described unless otherwise specified. Order assembly device 400 has four side regions 402a-d and three order assembly areas 406a-c. Order assembly area 406b has a top, horizontal planar surface 408. Surface 408 is divided into a plurality of sub-assembly areas 410a-h. The sub-assembly areas 410 are divided by dividers 412. Dividers 412 may be printed lines on surface 408, lines etched in surface 408, or raised dividers. Sub-assembly areas 410 may be numbered with designations or numerals 414. Preferably, each sub-assembly area 410a-h corresponds to a specific one of point-of-sale (“POS”) registers or terminals 416a-h in the restaurant. Order assembly area 406b has a plurality of container receptacles 418a-e for bags 420 or boxes. Container receptacles 418a-e may extend below planar surface 408 to increase the storage capacity of receptacles 418a-e. Container receptacles 418 may have a spring mechanism such as a coil spring or a leaf spring as are known in the art for pushing bags 420 forward as bags 420 in receptacles 418 are depleted. Below order assembly area 406b is a cabinet 421 for storage of containers and other supplies.

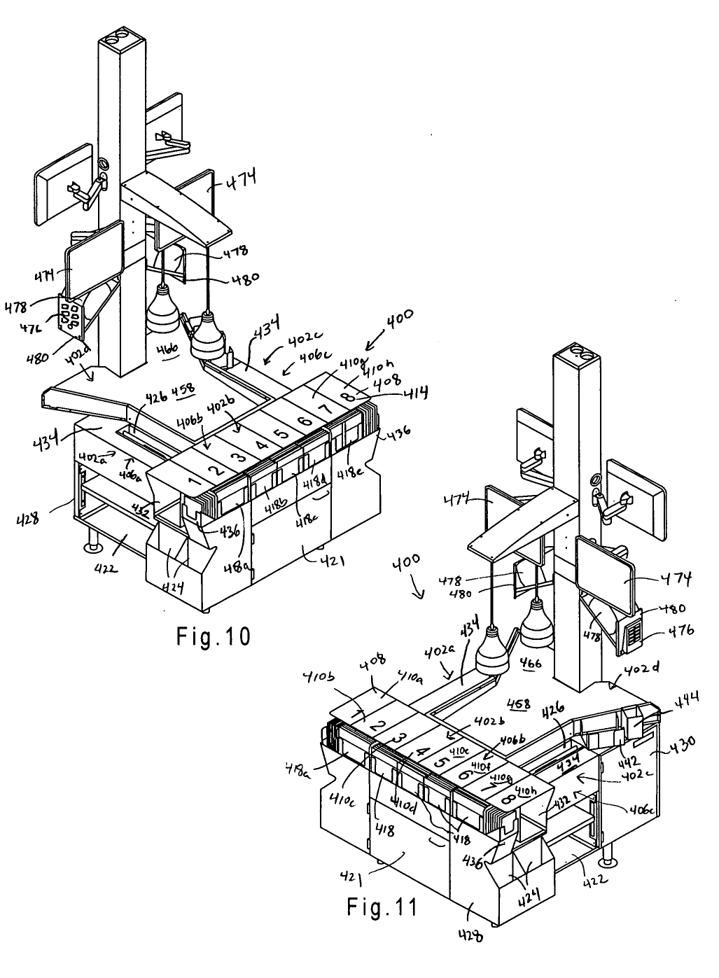

As illustrated in FIGS. 10-11, order assembly areas 406a and 406c are substantially similar. Both have open shelves 422, open top bins 424, container receptacle 426 having a hanging bar or divider 427 and cavity 432 in the base 428 of the order assembly device 400. Cavity 432 may be used to house bins similar to bins 192. The bins may be slidably mounted within cavity 432. Order assembly area 406c also has a cabinet 430 in base 428. Cabinet 430 may be an electrical cabinet. Order assembly areas 406a and 406c have top-accessible container receptacles 436 and assembly support surface 434 for supporting a container for an order while the order is assembled. Order assembly area 406c also has top-mounted napkin and straw receptacles 442 and 444. Order assembly areas 406a and 406c may vary significantly from each other and from areas 406a and 406c as illustrated to be more specific for drive-thru service or service within the restaurant in accordance with the modularity concepts described in conjunction with the unassembled device. Also, order assembly areas 406a and 406c may be removed so that device 400 has only two order assembly areas 400 in which case device 400 may have a tray receptacle and printer stand similar to tray receptacle 254 and printer stand 280.

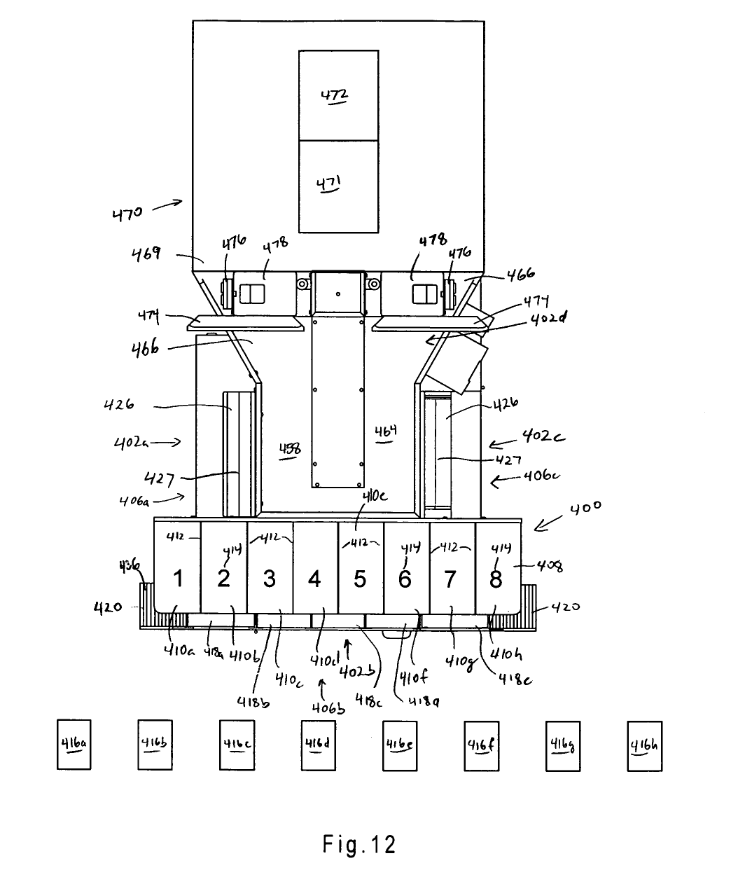

Similar to order assembly device 100, order assembly device 400 has a heated holding area 458, a ramp 466, displays 474, bump bars 476, and printers 478 on stands 480. Ramp 466 at its widest end preferably has substantially the same width as the adjoining end 469 of food preparation device 470 as seen in FIG. 12 for ease of transferring prepared food items from device 470 to food order assembly device 400. Food preparation device 470 may be any device suitable for preparing or assembling food items like sandwiches. Device 470 may have cold storage 471 for maintaining food items at 40° F. or below such as condiments selected from the group consisting of onions, tomatoes, lettuce and combinations thereof. Alternatively or in addition to cold storage 471, device 470 may have hot storage 472 for maintaining food items at 140° F. or above such as cooked hamburger patties, chicken nuggets, bacon, etc. Ramp 466 narrows at its narrowest end to match the width of portion 464. Ramp 466 facilitates the transfer and sliding of prepared food items like sandwiches from food preparation device 470 to portion 464 of heated holding area 458. Alternatively or in conjunction with ramp 466, there may be a conveyor (not shown) for conveying prepared food items including packaged sandwiches. Ramp 466 can be heated like portion 464 of holding area 458 or unheated.

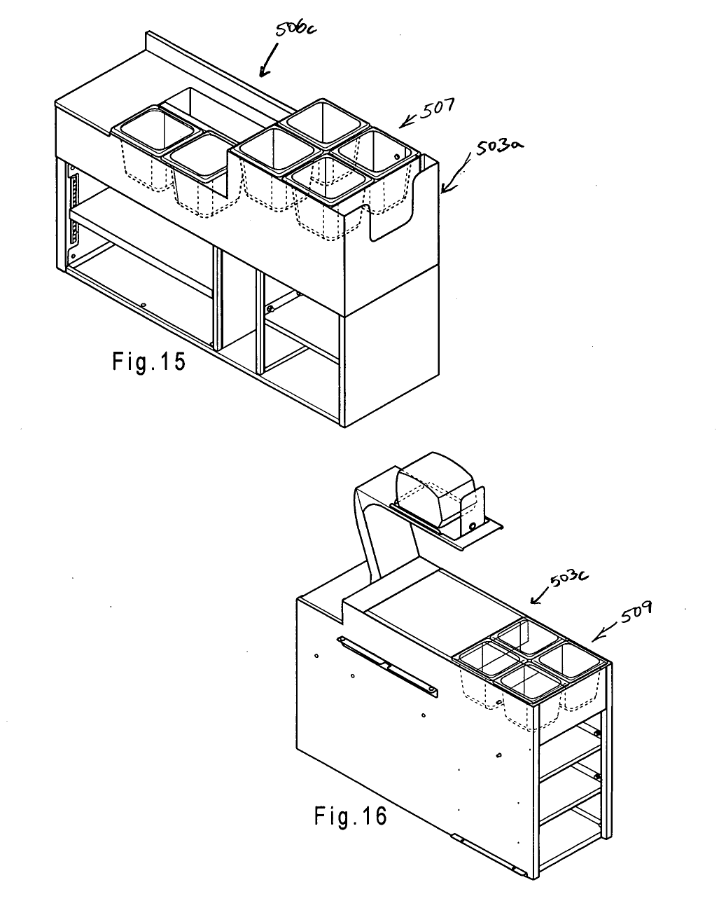

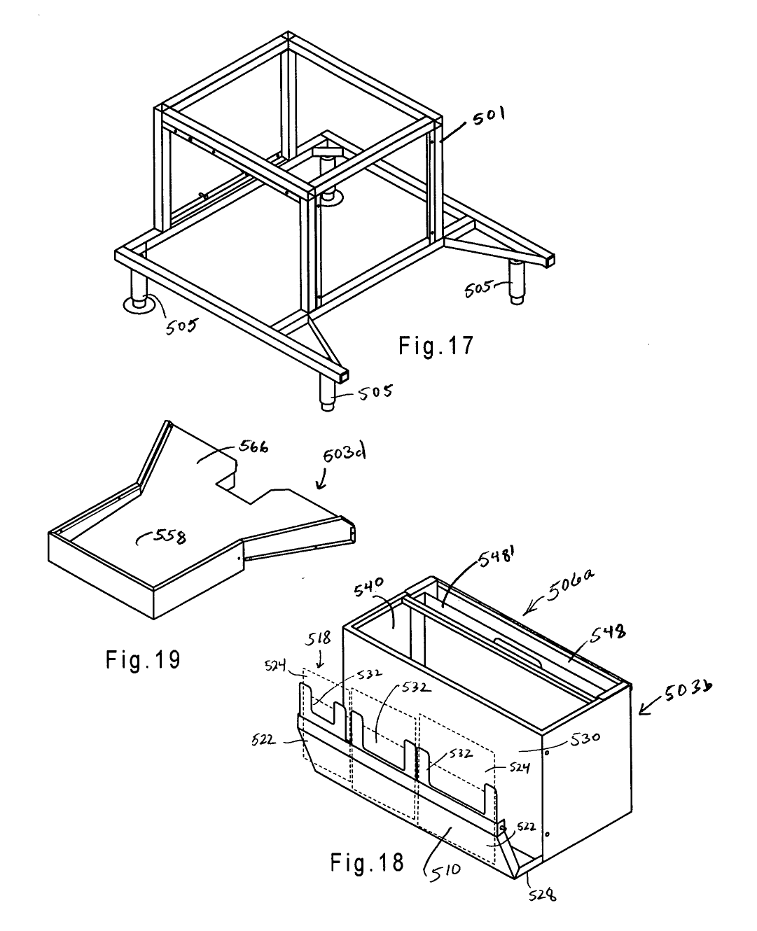

Food order assembly devices may be of any suitable construction. Preferably, the food order assembly devices are of modular construction. A most preferred construction is shown in FIGS. 15-19. FIGS. 15-19 collectively show an unassembled food order assembly device. The unassembled device has a frame 501 and modules 503a-d. Frame 501 has legs 505. Modules 503a-d are designed to be mounted to frame 501 so frame 501 and legs 505 support the entire weight of the unassembled device. Left module 503a mounts on the left side of frame 501 and includes drive-thru assembly area 506c. Front module 503b mounts on the front of frame 501 and includes much of order assembly area 506a. Module 503b has a well 540 in which pans can be placed and plastic bag receptacle 548 having divider 548′. Right module 503c mounts on the right side of frame 501. Core module 503d mounts on top of frame 501 and includes holding area 558 and ramp 566. The size of front module 503b relative to side modules 503a and 503c can be varied such that the front module includes some or all of corner areas 507 and 509.

Modularity provides a number of advantages. For example, the unassembled device may be converted to have three order assembly areas rather than two merely by replacing right module 503c with a module having some or all of an order assembly area. In addition, the unassembled device may have a drive-thru order area on its right side rather than on the left side with the installation of the appropriate modules, in which case the unassembled device can be the same or substantially similar to device 200. Also, the unassembled device may be improved to take advantage of new and better designs by replacing old modules with new modules. Generally, with modularity, the unassembled device may be configured and reconfigured to match the needs of a specific store or restaurant.

The food order assembly devices may be modular and be of different constructions. For example, modules 503a-c could be designed to stand directly on the floor. The unassembled device could be frameless and modules 503a-c could attach to each other to form a base to which core module 503d attaches. Modules 503a-d may attach to each other or to frame 501 by any way known in the art.

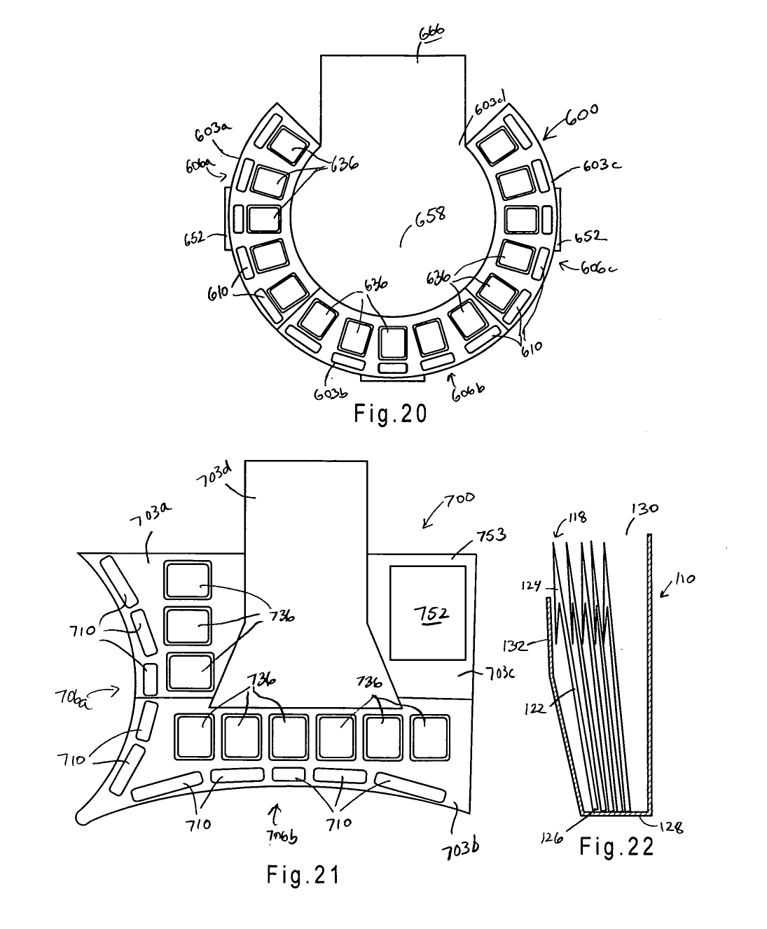

The order assembly devices are not limited to specific shapes or geometries and the number of assembly areas may exceed 3. For example, a circular food order assembly device 600 is shown in FIG. 20. Circular food order assembly device 600 has four modules 603. Order assembly modules 603a-c may be identical. Each module 603a-c corresponds to an order assembly area 606a-c. The number of order assembly areas 606 may be increased to 4, 5 or 6 typically by increasing the number of order assembly modules 603 or by increasing the number of order assembly areas 606 per order assembly module 603a-c. Module 603d is a core module having a holding area 658 and a ramp 666. Each order assembly area has container receptacles 610, receptacles 636 which may be used with pans, and shelves for holding trays 652.

A concave embodiment 700 of a food order assembly device is shown in FIG. 21. Order assembly device 700 has modules 703a-d and order assembly areas 706a-b. Each order assembly area has container receptacles 710 and receptacles 736 which may be used with pans. Trays 752 are located on planar surface 753.

Device bases 168, 268 and 368 can have a variety of different sizes based on the space available at a restaurant, the things to be held in the device, the types and amount of customers to be served, etc. Device bases 168, 268 and 368 may be nominally about 36″ tall, 48″ deep and 48″ wide, not including any bag receptacles mounted to the exterior of the base. Holding areas 158, 258 and 358 may be, for example, nominally about 20″ deep and 25″ wide, 18″ deep and 20″ wide not including ramps 166, 266 or 366, or any other dimensions suitable for the food to be held. Typically, bottom 162, 262, 362 is recessed below the top of bases 168, 268 and 368 by about 4″ in the back and about 5″ in the front. The center of displays 174 and 274 may be located about 65.5″, about 68.4″, about 79.5″, or any other suitable height above the floor. Devices of the invention could also include cup dispensers. Devices of the invention preferably do not include refrigerated areas. Devices of the invention may be made of any suitable food-safe material such as stainless steel or aluminum, particularly for holding areas 158, 258 and 358, polycarbonate, particularly for pans 338 and 397, wood coated with melamine, polypropylene, polyethylene, and any other suitable material as desired.

The invention also includes a method of assembling an order of food at a quick-service restaurant. At a quick-service restaurant having a plurality of POS terminals, which may be colloquially known as cash registers, food may be ordered at any one of the POS terminals. The ordered food may include food items such as sandwiches, which may be selected from, for example, breakfast, lunch and dinner items, and more particular non-limiting examples are hamburger sandwiches, chicken sandwiches, fish sandwiches, breakfast sandwiches and items, for example. The ordered food items are prepared and frequently packaged, typically in response to the order. The prepared food items are placed in a heated holding area of an order assembly device. Typically, the prepared food item is warm or hot. Food items for more than one order may be packaged and present on the heated holding area at the same time. The device has a first side on a first side of the device and a second side on a second side of the device. The first side has a plurality of first side receptacles accessible to a worker at the first side. The second side has a plurality of second side receptacles accessible to a worker at the second side. The heated holding area is adjacent to the first and second sides. The plurality of first and second side receptacles includes a container receptacle for holding food containers, such as a bag, box or tray. Optionally, one of the sides may have a horizontal, planar order assembly surface divided into specific areas, each of the areas designated as corresponding to a specific POS terminal.

A human-readable display displays the order for workers at the device. A food container is obtained from the container receptacle and placed onto the planar order assembly surface in the area corresponding to the POS terminal at which the order was taken. Placed food items are taken from the heated holding area and placed in the placed food container according to the order displayed. Additional items may also be placed in the food container. These additional items may include napkins, potato chips, fries, straws, cutlery, beverages, and various pre-packaged condiments. Some or all of the additional items may be obtained from specific receptacles of the device. It is to be noted that other items needed to entirely complete the order may be necessary, depending on the items contained or in the order assembly device. For example, items not contained on the order assembly device may include, depending upon a particular configuration, ice cream products, fountain beverages, non-fountain beverages, French fries, salads and soups. Alternatively, provision could be made to have all of the items necessary to complete an order contained on and/or in the order assembly device. An input is made into an input interface associated with the device and the human-readable display for indicating that the order has been assembled or served. This input then causes the display to display another order.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

What is claimed is:

1. A multisided, self-contained order assembly device for assembling food orders from customers from prepared food items at a quick-service restaurant, the assembly device comprising:
a first side having an outer periphery at which food orders can be assembled by a first worker, the first side having a plurality of first side receptacles accessible to the first worker at the outer periphery of the first side;
a second side having an outer periphery at which food orders can be assembled by a second worker, the second side having a plurality of second side receptacles accessible to the second worker at the outer periphery of the second side;
an at least generally centrally located food item holding area for holding prepared food items, the food item holding area accessible to a first worker located at the outer periphery of the first side and accessible to a second worker located at the outer periphery of the second side; and
a food inlet side, distinct from the first and second sides through which the prepared food items may pass to the food item holding area.

2. The order assembly device of claim 1 wherein the food inlet side has an inlet portion, the food inlet portion sloping downwardly from the food inlet side towards the food item holding area for encouraging prepared food items to slide towards the food item holding area.

3. The order assembly device of claim 1 further comprising a heater for heating the food item holding area.

4. The order assembly device of claim 1 further comprising a radiant heat source for heating food contained in the food item holding area.

5. The order assembly device of claim 4 wherein at least a portion of the food item holding area has a dark surface for absorbing radiant heat from the radiant heat source.

6. The order assembly device of claim 1 further comprising a third side at which food orders can be assembled by a third worker, the third side having a plurality of third side receptacles accessible to the third worker at the outer periphery of the third side, the food item holding area being accessible by a worker located at the outer periphery of the third side.

7. The order assembly device of claim 1 wherein the plurality of first side receptacles comprises a bag receptacle sized and configured to hold a plurality of folded bags in a substantially vertical alignment.

8. The order assembly device of claim 7 wherein the bag receptacle has a base and an open top, the base being narrower than the top for facilitating the loading and removal of the folded bags in an upside down position.

9. The order assembly device of claim 8 wherein the bag receptacle has an at least partially open front configured to retain a plurality of bags, each bag having a bag body and a bag bottom, in an upside down folded configuration in which the bottom of the bag is generally vertically oriented with the bottom of each bag facing outwardly and generally parallel to the bag body, to allow a hand of a worker to slip between the bag body and the bag bottom of an upside-down folded bag in the bag receptacle.

10. The order assembly device of claim 1 wherein the plurality of first and second side receptacles comprises a plurality of bag receptacles sized for holding different sized bags.

11. The order assembly device of claim 10 further comprising a drawer sized and configured to hold the same types of bags as the bag receptacles.

12. The order assembly device of claim 1 wherein the plurality of first and second side receptacles comprises a plurality of interchangeable movable bins seated in one or more cavities in the order assembly device.

13. The order assembly device of claim 10 further comprising a drawer configured to seat a plurality of the interchangeable movable bins.

14. A system for assembling food orders from customers at a quick-service restaurant comprising a multisided self-contained order assembly device that comprises:
a first side having an outer periphery at which food orders can be assembled by a first worker, the first side having a plurality of first side receptacles accessible to the first worker at the outer periphery of the first side;
a second side having an outer periphery at which food orders can be assembled by a second worker, the second side having a plurality of second side receptacles accessible to the second worker at the outer periphery of the second side;
an at least generally centrally located food item holding area for holding prepared food items, the food item holding area accessible to a first worker located at the outer periphery of the first side and accessible to a second worker located at the outer periphery of the second side; and
a food inlet side, distinct from the first and second sides, through which the prepared food items may pass to the food item holding area.

15. The system of claim 14 further comprising a sandwich preparation device for preparing sandwiches.

16. The system of claim 15 wherein the sandwich preparation device comprises cold storage for holding condiments selected from the group consisting of onions, tomatoes, lettuce and combinations thereof.

17. The system of claim 15 further comprising means for transferring sandwiches prepared at the sandwich preparation device to the food item holding area.

18. The system of claim 17 wherein the means for transferring sandwiches comprises a ramp connected to and sloping towards the food item holding area.

19. The system of claim 14 further comprising a human-readable display for displaying orders to be assembled, the display oriented to be viewable by a worker working at one of the first and second sides.

20. The system of claim 19 further comprising an input interface for indicating the completion of an order displayed on the human-readable display.

21. A method of assembling an order of food at a multisided, self-contained order assembly device for assembling food orders from customers from prepared food items comprising a first side having an outer periphery at which food orders can be assembled by a first worker, the first side having a plurality of first side receptacles accessible to the first worker at the outer periphery of the first side; a second side having an outer periphery at which food orders can be assembled by a second worker, the second side having a plurality of second side receptacles accessible to the second worker at the outer periphery of the second side; an at least generally centrally located food item holding area for holding the prepared food items, the food item holding area accessible to a first worker located at the outer periphery of the first side and accessible to a second worker located at the outer periphery of the second side; and a food inlet side, distinct from the first and second sides, through which the prepared food items may pass to the food item holding area, the method comprising:
ascertaining food order items needed to fill an order;
selecting an appropriate order container from one of the first or second side receptacles;
obtaining order items from the food item holding area; and
placing/depositing the obtained order items into the selected order container.

22. The method of claim 21 further comprising placing prepared food order items in the food item holding area.
